(19) United States
(12) Patent Application Publication
(10) Pub. No.: US 2009/0240668 A1
(43) Pub. Date: Sep. 24, 2009

(54) System and method for embedding search capability in digital images

(76) Inventor: Yi Li, Wellesley, MA (US)

Correspondence Address: Yi Li, 54 Oak Street, Wellesley, MA, 02482, US

(21) Appl. No.: 12/406,939

(22) Filed: Mar. 18, 2009

Related U.S. Application Data
(60) Provisional application No. 61/069,860, filed on Mar. 18, 2008.

(51) Int. Cl. G06F 17/30; G10L 15/00

(52) U.S. Cl. 707/3; 704/251; 707/E17.02; 704/251; 382/232; 345/619; 707/E17.014; 707/E17.015

(57) ABSTRACT

This invention is a system and method that enables image viewers to search for information about objects, events or concepts shown or conveyed in an image through a search engine. The system integrates search capability into digital images seamlessly. When viewers of such an image want to search for information about something they see in the image, they can click on it to trigger a search request. Upon receiving a search request, the system will automatically use an appropriate search term to query a search engine. The search results will be displayed as an overlay on the image or in a separate window. Ads that are relevant to the search term are delivered and displayed alongside search results. The system also allows viewers to initiate a search using voice commands. Further, the system resolves ambiguity by allowing viewers to select one of multiple searchable items when necessary.

### CROSS-REFERENCE TO RELATED APPLICATIONS

This application claims the benefit of U.S. Provisional Patent Application No. 61/069,860, filed Mar. 18, 2008, entitled “System and method for embedding search capability in digital images.” The entirety of said provisional patent application is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention is directed towards digital image systems with embedded search capability, and more particularly towards a system and method that enable image viewers to search for information about objects, events or concepts shown or conveyed in digital images.

2. Description of Prior Art

Web search is an effective ways for people to obtain information they need. To conduct a regular web search, a user goes to the web site of a search engine, enters a search term (one or more key words), and the search engine will return a list of search results. However, when viewers of a digital image want to search for information about something shown in the image, there is not a fast and natural way for them to conduct a web search. Also, oftentimes viewers cannot formulate an appropriate search term that accurately describes the object or event shown in the image that interests them, so they cannot find the information they are looking for through web searches.

Accordingly, there is a need for a digital image system with built-in search capability, which allows viewers to search for information about objects, events or concepts shown or conveyed in a digital image in a fast and accurate way.

### BRIEF SUMMARY OF THE INVENTION

The present invention embeds search capability into digital images, enabling viewers to search for information about objects, events or concepts shown or conveyed in an image. In an authoring process, a set of objects, events or concepts in an image are defined as searchable items. A set of search terms, one of which being the default, are associated with each searchable item. When viewing the image, a viewer can select a searchable item to initiate a search. The digital image system will identify the selected item and use its default search term to query a search engine. Search results will be displayed in a separate window or as an overlay on the image. Other search terms associated with the selected searchable item will be displayed as search suggestions to allow the viewer to refine her search.

The present invention employs two methods for a viewer to select a searchable item and for the digital image system to identify the selected item.

In one method, searchable items' locations in the image are extracted and stored as a set of corresponding regions in an object mask image. To select an item, a viewer clicks on the item with a point and click device such as a mouse. The digital image system will identify the selected item based on location of the viewer's click.

In another method, speech recognition is used to enable viewers to select searchable items using voice commands. During the authoring process, a set of synonyms are associated with each searchable item. To select an item, a viewer simply speaks one of its synonyms. If the viewer's voice input can be recognized by the speech recognition engine as one of the synonyms for a particular searchable item, that item will be identified as the selected item.

Each of these methods can be used alone, or they can be used in conjunction with each other to give viewers more options for searchable item selection.

### BRIEF DESCRIPTION OF THE SEVERAL VIEWS OF THE DRAWING

The present invention is illustrated by way of example, and not by way of limitation, in the figures of the accompanying drawings and in which like reference numerals refer to similar elements and in which:

FIG. 1 is a system diagram illustrating key components of the present invention for an illustrative embodiment;

FIG. 2 is a flow chart illustrating the sequence of actions in a typical usage scenario of the present invention;

FIGS. 3A-B illustrate a set of example screen views for the illustrative embodiment of the present invention, showing the results of a search about a person in an image; and

FIG. 4 illustrates another example screen view for the illustrative embodiment of the present invention, showing the results of a search about a travel destination in an image.

### DETAILED DESCRIPTION OF THE INVENTION

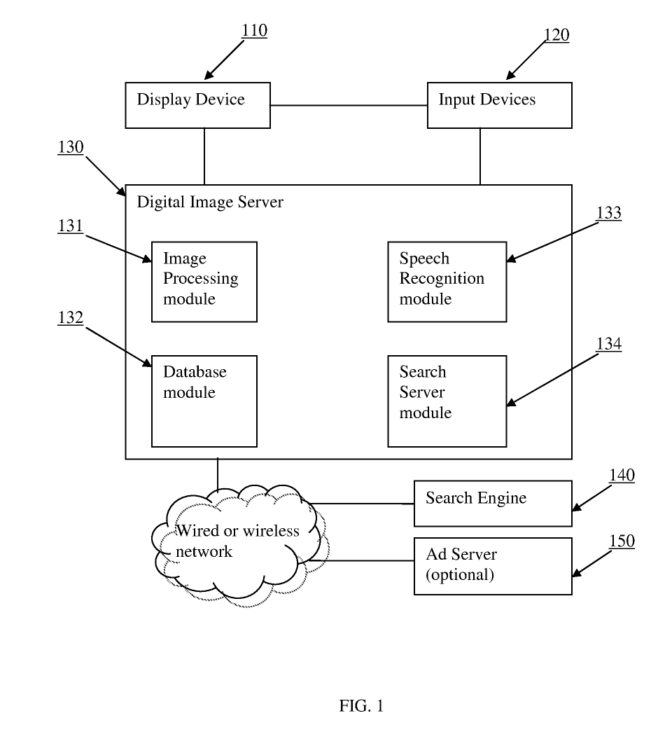

Refer first to FIG. 1, which illustrates key components of an illustrative embodiment of the present invention. The system consists of a Display Device 110, one or more Input Devices 120, and a Digital Image Server 130, which is connected to a Search Engine 140 and an optional Ad Server 150 through a wired or wireless network.

The Display Device 110 can be a TV set, a computer monitor, a touch-sensitive screen, or any other display or monitoring system. The Input Device 120 may be a mouse, a remote control, a physical keyboard (or a virtual on screen keyboard), a microphone (used in conjunction with a speech recognition engine to process viewers' voice commands), or an integral part of a display device such as a touch-sensitive screen. The Digital Image Server 130 may be a computer, a digital set-top box, a digital video recorder (DVR), or any other devices that can process and display digital images. The Search Engine 140 may be a generic search engine, such as Google, or a specialized search engine that searches a retailer's inventory or a publisher's catalog. The Ad Server 150 is optional. It is not needed if the Search Engine 140 has a built-in ad-serving system like Google's AdWords. Otherwise, the Ad Server 150, which should be similar in functionality to Google's AdWords, is required. Further, the above components may be combined into one or more physical devices. For example, the Display Device 110, the Input Device 120 and the Digital Image Server 130 may be combined into a single device, such as a media center PC, an advanced digital TV, or a cell phone or other portable devices.

The Digital Image Server 130 may comprises several modules, including an Image Processing module 131 (used for image coding/decoding and graphics rendering), a Database module 132 (used to store various information of searchable items), a Speech Recognition module 133 (used to recognize viewers' voice input), and a Search Server module 134 (used to query the Search Engine 140 and process returned search results). The Image Processing module 131 is a standard component in a typical PC, set-top box or DVR. The Database module 132 is a combination of several types of databases, which may include SQL tables, plain text tables, and image databases. The Speech Recognition module 133 can be built using commercial speech recognition software such as IBM ViaVoice or open source software such as the Sphinx Speech Recognition Engine developed by Carnegie Mellon University.

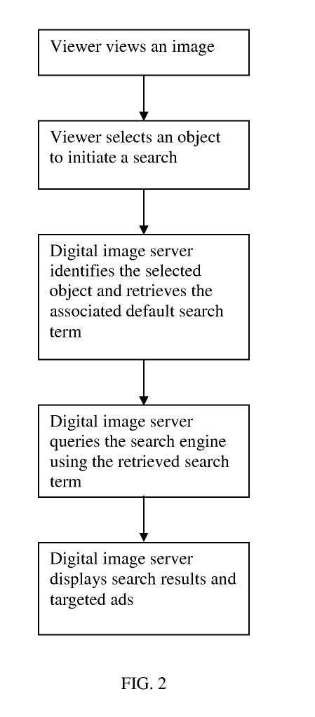

In a typical usage scenario, when a viewer wants to know more information about an object shown in an image, she can select that object to initiate a search using the Input Device 120. For example, she can click on the object using a mouse. This will trigger a sequence of actions. First, the Digital Image Server 130 will identify the clicked object, and retrieve a default search term associated with the identified object from a database. Then, it will query the Search Engine 140 using the retrieved search term. And finally, it will display the results returned by the search engine either as an overlay or in a separate window. Targeted ads will be served either by the built-in ad serving system of the Search Engine 140 or by the Ad Server 150. The sequence of actions described above is illustrated in FIG. 2.

The ensuing discussion describes the various features and components of the present invention in greater detail.

### 1. Defining Searchable Items

In order to enable viewers to conduct a search by selecting an item in an image, one or more searchable items that might be of interest to viewers need to be defined in an authoring process, either by an editor or, in certain situations, by viewers themselves. There is no restriction on the types of items that can be made searchable. A searchable object can be a physical object such as an actor or a product, or a non-physical object such as a recipe or a geographical location. It can also be something not shown, but conveyed in the image, such as a concept. Examples of searchable events include natural events, such as a snowstorm, sports events such as the Super Bowl, or political events, such as a presidential election.

The process of defining a searchable item involves extracting certain information about the item from the image and storing the extracted information in a database in the Database module 132 in FIG. 1. The present invention employs a location-based method and a speech recognition based method for viewers to select a searchable item and for the digital image system to identify the selected item.

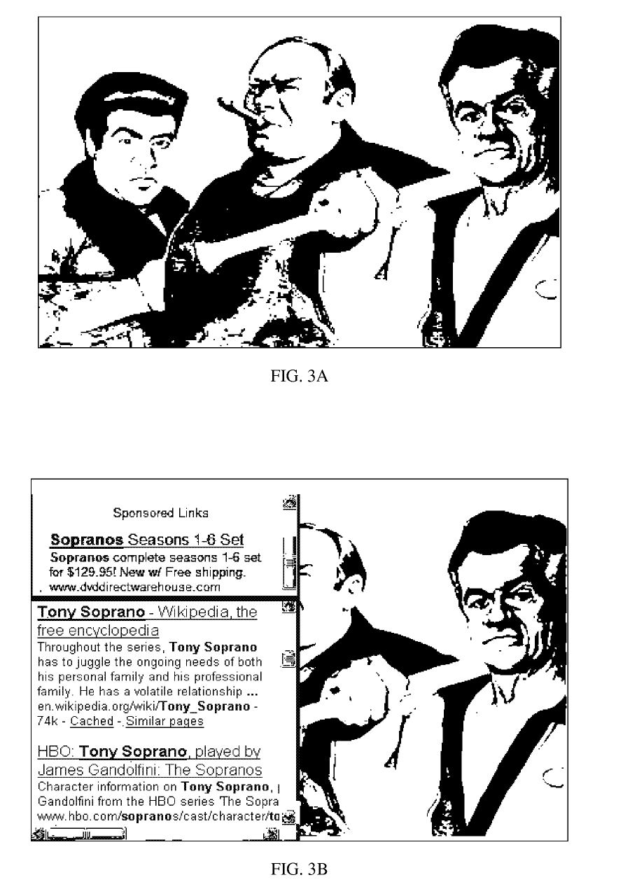

In the location-based method, a searchable item's location, in terms of corresponding pixels in the image, is extracted. All the pixels belonging to the item are grouped and labeled as one region, which is stored in an object mask image database in the Database module 132. (An object mask image has the same size as the image being processed.) When a viewer clicks on any pixel within a region, the corresponding item will be identified as the item selected by the viewer. FIG. 3 A shows an example image, which contains characters from the HBO drama “The Sopranos”. The character “Tony Soprano” is a searchable item. When the viewer clicks on the character, the Digital Image Server 130 will use the default search term “Tony Soprano” to query the search engine. FIG. 3 B illustrates an example screen view according to an embodiment of the present invention, showing the search results and targeted ads, which are listed as overlays on the image. The images in these figures and the subsequent figures are for exemplary purposes only, and no claim is made to any rights for the images and their related TV shows displayed. All trademark, trade name, publicity rights and copyrights for the exemplary images and shows are the property of their respective owners.

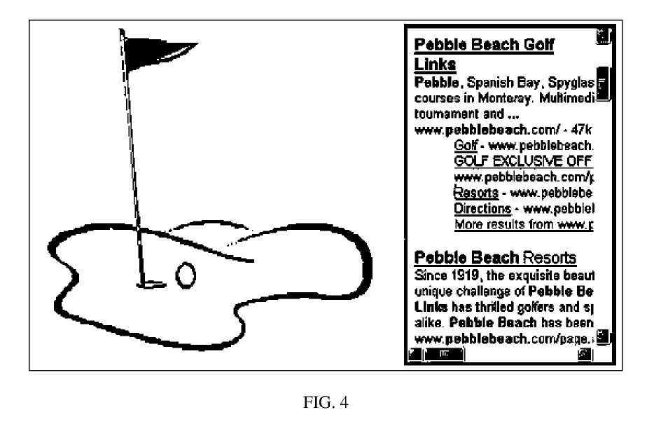

Oftentimes the viewer wants to search for information about something that is not a physical object. For example, the viewer may want to search for related stories about a news event shown in an image, or she may want to search for information about a travel destination shown in an image, or she may want to search for more information about a recipe when she sees a picture of a famous cook. In these cases, the searchable items don't correspond to a particular region in an image. However, the entire image can be defined as the corresponding region for these types of non-physical searchable items, so viewers can trigger a search by clicking anywhere in the image. FIG. 4 shows such an example. It is a picture of a famous golf course, where Pebble Beach Golf Links is defined as a searchable item. The screen view shows the results of a search using the default search term “pebble beach golf links”.

The speech recognition based method is another alternative for item selection and identification used by the present invention. It enables viewers to select searchable items using voice commands. During the authoring process, each searchable item is associated with a set of words or phrases that best describe the given item. These words or phrases, which are collectively called synonyms, are stored in a database in the Database module 132. It is necessary to associate multiple synonyms to a searchable item because different viewers may call the same item differently. For example, the searchable item in FIG. 3 A, which is the character “Tony Soprano”, is associated with four synonyms: “Tony Soprano”, “Tony”, “Soprano”, and “James Gandolfini” (which is the name of the actor who plays “Tony Soprano”). When the viewer speaks a word or phrase, if the speech recognition engine can recognize the viewer's speech input as a synonym of a particular item, that item will be identified as the selected item.

### 2. Associating Search Terms With Searchable Items

After searchable items are defined, a set of search terms are associated with each searchable item, and are stored in a database in the Database module 132 in FIG. 1. Since viewers may search for information about different aspects of a searchable item, multiple search terms can be assigned to a single searchable item, and one of them is set as the default search term. For example, the searchable item in FIG. 3 A, which is the character “Tony Soprano”, is associated with two search terms: “Tony Soprano” (which is the default search term) and “James Gandolfini”. When viewers select an item, the default search term will be used to query the search engine automatically. The other search terms will be listed as search suggestions, either automatically or upon viewers' request, to allow viewers to refine their search. The Digital Image Server 130 keeps track of what items viewers select and what search terms viewers use for each item. Over time, the most frequently used search term for a given searchable item can be set as new default, replacing the initial default search term for that item. Some of the synonyms for speech recognition can also be used as search terms.

### 3. Item Selection And Identification

The present invention allows viewers to select a searchable item to initiate a search using two types of input devices: (1) Point and click devices, such as a mouse, a remote control, a stylus, or a touch sensitive screen; (With additional hardware and software, the viewer can also select an object to search using a laser pointer.) (2) Speech input device, such as a microphone.

As mentioned earlier, the present invention employs a location-based method and a speech recognition based method for item selection and identification. Each of these methods can be used alone, or they can be used in conjunction with each other to give viewers more options for item selection. In the location-based method, a viewer selects a searchable item by clicking on it with a mouse or a remote control, or with a finger or stylus if the image is being viewed on a touch sensitive screen. The Digital Image Server 130 in FIG. 1 will first determine which pixel in the image is being clicked on. Then it will identify the region that contains the clicked-on pixel. Finally, this region's corresponding item will be identified as the selected searchable item. In an implementation variation of the present invention, when the viewer moves the cursor of the mouse into a searchable item's region, the Digital Image Server 130 will highlight the item and display its search terms in a small window to indicate that the item is searchable. The viewer can initiate a search by either clicking on the highlighted item or clicking on one of its listed search terms.

In the speech recognition based method, instead of clicking on a searchable item, the viewer can speak the name or a synonym of the searchable item to initiate a search. The microphone will capture the viewer's speech and feed the speech input to the Speech Recognition module 133 in FIG. 1. If the viewer's speech input can be recognized as a synonym of a particular searchable item, that item will be identified as the selected item.

### 4. Resolving Ambiguity

In the location-based method, if two or more searchable items' regions overlap and the viewer clicks on the overlapped region, ambiguity arises because the Digital Image Server 130 can't tell which item the viewer intends to select. To resolve this ambiguity, the Digital Image Server 130 displays the default search terms of all the ambiguous items, and prompts the viewer to select the intended one by clicking on its default search term. Similarly, in the speech recognition based method, ambiguity arises when the viewer speaks a word or phrase that is a synonym for two or more searchable items. The Digital Image Server 130 resolves ambiguity by listing the ambiguous items' synonyms on the screen (each synonym should be unique to its corresponding item), and prompting the viewer to select the intended item by speaking its corresponding synonym.

### 5. Query Search Engines And Display Search Results

Once the searchable item selected by the viewer is identified, The Search Server module 134 in FIG. 1 will use its default search term or the search term selected by the viewer to query the Search Engine 140. The search term being used will be displayed in a status bar superimposed on the screen, indicating that the system is conducting the requested search. In addition to a set of search results, highly targeted ads based on the search term will also be returned by the built-in ad-serving system of the Search Engine 140 and/or by the optional Ad Server 150. These ads are not irritating because they are only displayed when viewers are searching for information. They are highly effective because they closely match viewers' interests or intentions revealed by their searches.

Search results and targeted ads can be displayed in a number of ways. They can be displayed in a separate window, or in a small window superimposed on the video screen, or as a translucent overlay on the video screen. Viewers can choose to navigate the search results and ads immediately, or save them for later viewing.

If the selected searchable item is associated with multiple search terms, the additional search terms will be displayed as search suggestions to allow the viewer to refine her search. The viewer can click on one of the suggestions to initiate another search.

In a generic search engine like Google, multiple content types, such as web, image, video, news, maps, or products, can be searched. In one implementation, the Search Server module 134 searches multiple content types automatically and assembles the best results from each of the content types. In an implementation variation, the searchable items are classified into different types during the authoring process, such as news-related, location-related, and product-related. The Search Server module 134 will search a specific content type in Google based on the type of the selected searchable item. For example, if the viewer selects to search for related stories about a news event in an image, Google news will be queried; if the viewer selects to search for the location of a restaurant in an image, Google map will be queried. The Search Server module 134 can also query a specialized search engine based on the type of the selected searchable item. For example, if the viewer selects a book in an image, a book retail chain's online inventory can be queried.

While the present invention has been described with reference to particular details, various changes and substitutions are intended in the foregoing disclosures, and it will be appreciated that in some instances some features of the invention will be employed without a corresponding use of other features without departing from the scope and spirit of the invention. Therefore, many modifications may be made to adapt a particular situation to the essential scope and spirit of the present invention. It is intended that the invention not be limited to the particular terms used in the descriptions and/or to the particular embodiment disclosed as the best mode contemplated for carrying out this invention, but that the invention will include any and all embodiments and equivalents falling within the scope of the invention.

What I claim as my invention is:

1. A method for embedding search capability in digital images, the method comprising the steps of:
a. Defining searchable items in a digital image;
b. Associating, with each searchable item, at least one search term;
c. Requesting a search by selecting a searchable item;
d. Identifying the selected searchable item; and
e. Querying at least one search engine using a search term associated with the identified searchable item, and displaying the returned search results.

2. The method of claim 1, wherein said defining searchable items is based on identifying, for each searchable item, its location in the digital image.

3. The method of claim 1, wherein said defining searchable items is based on associating, with each searchable item, at least one word or phrase for speech recognition.

4. The method of claim 1 or claim 2, wherein said selecting a searchable item and said identifying the selected searchable item comprising the steps of:
a. Clicking on the digital image to select a searchable item;
b. Identifying the location within the digital image that is being clicked on; and
c. Identifying the searchable item in the digital image that corresponds to the identified location that is being clicked on.

5. The method of claim 1 or claim 3, wherein said selecting a searchable item and said identifying the selected searchable item comprising the steps of:
a. Speaking a word or phrase that is associated with a searchable item;
b. Recognizing the word or phrase that is spoken using a speech recognition engine; and
c. Identifying the searchable item that is associated with the recognized word or phrase.

6. The method of claim 1, further comprising the step of: Generating and displaying a plurality of forms of targeted ads, based on the search term used to query the at least one search engine.

7. The method of claim 1, further comprising the step of: Displaying two or more searchable items' unique search terms to resolve ambiguity in the step of identifying the selected searchable item.

8. The method of claim 1, wherein said defining searchable items further comprising the step of: Classifying each searchable item to at least one of a plurality of types.

9. The method of claim 1 or claim 8, wherein said querying at least one search engine further comprising the step of: Querying one of a plurality of types of search engines based on the type of the selected searchable item.

10. A digital image system with embedded search capability, the system comprising:
a. A display device;
b. At least one input device;
c. A digital image server; and
d. At lease one search engine.

11. The system of claim 10, wherein the digital image server is connected with the at lease one search engine through a network.

12. The system of claim 10, wherein the digital image server comprising:
a. An image processing module, used for image coding/decoding and graphics rendering;
b. A database module, used for storing said searchable items' information;
c. A search server module, used for querying the at lease one search engine and processing returned search results.

13. The system of claim 10, wherein the digital image server further comprising: A speech recognition module, used for speech recognition.

14. The system of claim 10, further comprising: An ad server, used for generating search term based targeted ads, the ad server is connected with the digital image server through a network.
